(19) United States
(12) Patent Application Publication
(10) Pub. No.: US 2005/0142443 A1
(43) Pub. Date: Jun. 30, 2005

(54) Lead alloy for battery grids

(76) Inventors: Luis Francisco Vazquez Del Mercado, Monterrey (MX); Luis David Silva-Galvan, Monterrey (MX)

Correspondence Address: FOLEY & LARDNER, 777 EAST WISCONSIN AVENUE, SUITE 3800, MILWAUKEE, WI, 53202-5308, US

(21) Appl. No.: 10/994,197

(22) Filed: Nov. 18, 2004

Related U.S. Application Data
(63) Continuation-in-part of application No. 09/872,875, filed on Jun. 4, 2001, now abandoned.

(51) Int. Cl. H01M 4/68; C22C 11/06

(52) U.S. Cl. 429/226; 429/245; 29/2; 420/565

(57) ABSTRACT

A lead alloy for use in lead-acid battery grids consisting essentially of between approximately 0.05 and 0.07 percent calcium, between approximately 0.9 and 1.3 percent tin, between approximately 0.006 and 0.010 percent silver, between approximately 0.010 and 0.017 weight percent barium, and between approximately 0.015 and 0.025 percent aluminum, with the balance being lead.

### CROSS-REFERENCE TO RELATED PATENT APPLICATIONS

The present application is a continuation-in-part under 35 U.S.C § 120 of (and also expressly incorporates by reference herein in its entirety) the following related application: U.S. patent application Ser. No. 09/872,875 filed Jun. 4, 2001.

### BACKGROUND

The present application relates generally to the field of lead-acid batteries, and more specifically, to a silver-barium lead alloy for grids.

An important component in a lead-acid battery is the grid. This is used to support the positive and negative materials, and also to provide a conductive path for the current during the charge and discharge of the cell. Lead-acid battery manufacturers have available a variety of techniques for forming battery grids. Battery grids are typically made by adding the alloying constituents in the prescribed amounts to the molten lead and then mixing until the mass is homogeneous, after which the lead-acid battery grids are produced by gravity casting or are continuously formed by expanded metal fabrication techniques. In the most common gravity casting method, the molten alloy is fed into what is referred to as a book mold and is then allowed to solidify. In the expanded metal method, a rolled or wrought alloy strip or a cast strip is slit and expanded using reciprocating dies and then cut into the desired width and height dimensions to form the grid with a lug.

Attention has been given to the type of alloys used for manufacturing positive and negative grids. The selection of appropriate levels of elements for the battery grids involves considerations of grid-production capability, economic feasibility, and the metallurgical and electrochemical properties of the resulting alloys. Lead alloys preferably provide such properties as stiffness, strength, grain refinement, harness, corrosion resistance, processability and conductivity. It is generally accepted that the ultimate life of a lead-acid battery is largely determined by the positive grids.

One issue with known Pb—Ca—Sn—Ag—Al alloys is that cast grids made from these alloys require an age hardening treatment above room temperature to improve their hardness and strength required for the processing steps of the lead-acid battery manufacturing. Increasing the age hardening rate of an alloy tends to facilitate high rate, high volume battery production by shortening the time required for the alloy to achieve acceptable strength for processing. Increasing the maximum hardness without sacrificing corrosion resistance tends toward improving overall battery quality.

The use of silver as an alloy to improve corrosion resistance and performance of positive grids has been identified. An increase in silver use as an alloying element for lead-acid batteries has resulted in an increase of the silver content of recycled soft lead. The silver content is expected to continue to rise because of the difficulty of removing silver economically from recycled lead.

### SUMMARY

The present invention relates to a lead alloy for use in lead-acid battery grids consisting essentially of between approximately 0.05 and 0.07 percent calcium, between approximately 0.9 and 1.3 percent tin, between approximately 0.006 and 0.010 percent silver, between approximately 0.01 and 0.017 percent barium, and between approximately 0.015 and 0.025 percent aluminum, with the balance being lead.

The present invention also relates to a lead-acid battery that includes a container having a plurality of cells, each of the plurality of cells having an electrolyte and a plurality of positive grids. At least one of the plurality of positive grids comprises an alloy consisting essentially of between approximately 0.05 and 0.07 percent calcium, between approximately 0.9 and 1.3 percent tin, between approximately 0.006 and 0.010 percent silver, between approximately 0.010 and 0.017 percent barium, and between approximately 0.015 and 0.025 percent aluminum, with the balance being lead.

The present invention also relates to a method of producing a battery grid that includes providing a lead alloy consisting essentially of between approximately 0.05 and 0.07 percent calcium, between approximately 0.9 and 1.3 percent tin, between approximately 0.006 and 0.010 percent silver, between approximately 0.010 and 0.017 percent barium, and between approximately 0.015 and 0.025 percent aluminum, with the with the balance of the alloy being lead. The method also includes forming a grid from the lead alloy in a process that includes book mold gravity casting.

### BRIEF DESCRIPTION OF THE DRAWINGS

FIG. 1 is a graph of hardness test results performed at room temperature on battery grids manufactured from three different alloys.

FIG. 2 is a graph of overcharge corrosion test results performed during seven days at 60 deg. C. on battery grids manufactured from three different alloys.

FIG. 3 is a graph of a corrosion evaluation test using impedance measurements performed on battery grids manufactured from three different alloys.

### DETAILED DESCRIPTION OF EXEMPLARY EMBODIMENTS

According to an exemplary embodiment, an improved silver-barium lead alloy may be used to make lead-acid battery positive grids that improve the aging process at room temperature used to reach a hardness and strength intended for pasting, curing, and subsequent processing of said battery grids. Such an alloy may advantageously avoid the high temperature treatment required to speed up the hardening process of the Pb—Ca—Sn—Al—Ag alloys. Such an alloy may also provide relatively good creep corrosion resistance characteristics to the battery grids manufactured with said alloy, since internal electrical shorting due to grid growth is one of the most frequent modes of failure in the cells of these batteries.

According to an exemplary embodiment, a lead alloy may include alloy elements selected to provide a range of calcium, tin, silver, aluminum and barium which is intended to provide an optimum balance between the need to get hardening and strength by calcium and barium based precipitation reactions, and the creep corrosion resistance provided by the silver content of the alloy. It is intended that the finer microstructure produced during the solidification of the alloy will lead to reduced intergranular penetrating corrosion and improved creep resistance.

According to an exemplary embodiment, a positive grid includes an alloy containing about 0.05 to 0.07 wt percent calcium; about 0.9 to 1.3 wt percent tin; about 0.006 to 0.010 percent silver; about 0.0100 to 0.0170 wt percent barium and about 0.015 to 0.025 wt percent aluminum, with the balance being lead. Increased strength is believed to be attributable to the presence of barium atoms which lead the formation of different precipitates that block the crystals growing during solidification; the silver content of the alloy is intended to provide relatively good castability while avoiding hot cracks and hot tears.

According to an exemplary embodiment, the alloy is produced by adding the alloying constituents in the prescribed amounts to molten lead and then mixing until the mass is homogeneous. The lead-acid battery grids are then produced by gravity casting machines using book molds.

The Pb—Ca—Sn—Ag—Al alloy is considered a complex precipitation-hardening alloy deriving high mechanical strength, when age hardening at temperatures between 80 and 100 deg. C., and corrosion resistance is believed to be attributable to a relatively uniform dispersion of very fine intermetallic precipitates in the lead matrix. It has been found that the addition of barium as an alloying element to the Pb—Ca—Sn—Ag—Al alloy may lead to modifications of the microstructure of this alloy during solidification in order to lessen the need for age-hardening treatment at temperatures higher than the room temperature (as required by a conventional Pb—Ca—Sn—Ag—Al alloy) before pasting and curing, while retaining the creep corrosion resistance provided by the silver content of the alloy.

Alloy selection provides a range of calcium, tin, silver, aluminum and barium content which is intended to provide an optimum balance between the need to get hardening and strength by calcium and barium based precipitation reactions and the need to reduce the corrosion of grids leading to a finer microstructure during the solidification of the alloy.

The barium content of this lead based alloy should be maintained in the range of 0.0100 to 0.0170 wt percent. This range has been found, in conjunction with a calcium content of about 0.05 to 0.07 wt percent, to allow adequate mechanical properties while lowering the rate of lead matrix recrystallization and eliminating the high temperature age hardening required for lead-silver alloys.

Because silver is relatively difficult to eliminate from lead alloys (e.g. during recycling) and because of castability problems associated to silver high contents, it may be desirable to limit the silver content of lead alloys. It is believed that a silver content of about 0.006 to 0.010 wt percent and a tin content of about 0.9 to 1.3 wt percent may act to avoid the hot-cracks and hot-tear defects during the lead alloy casting and may provide high temperature corrosion resistance while reducing creep-induced deformation.

In order to prevent calcium and barium losses, aluminum additions from about 0.015 to 0.025 wt percent may be used in the alloy according to an exemplary embodiment.

The hardening rate and maximum hardness are both important indicators of the strength for a grid alloy. In addition to these two properties, automotive battery life may also be impacted by corrosion of the grid structure of the positive plate. (Strengthening and corrosion resistance of lead-acid batteries can be simulated by laboratory tests and by field tests with batteries working in real conditions to evaluate the potential of positive grids alloys to extend the service life of batteries. Reasonable correlation between laboratory tests and follow-up studies of battery life has been demonstrated.)

In order to evaluate the effect of silver and barium levels for manufacturability and extending life of the lead-acid batteries, a set of experiments were undertaken.

### Hardening Tests

Positive grids were cast in book molds using the conventional gravity casting method. The hardening process progress was evaluated for different alloys through their hardening rate at room temperatures. Samples were taken at different times after the casting of the grids. In this test, the rate at which the alloy hardness is performed by measuring hardness as a function of time. Vickers hardness measurements were carried out on an Instron Wilson Tukon 2100 hardness tester under a load of 200 gr. during 15 seconds. Points of measurement were distributed to obtain a mean sample hardness.

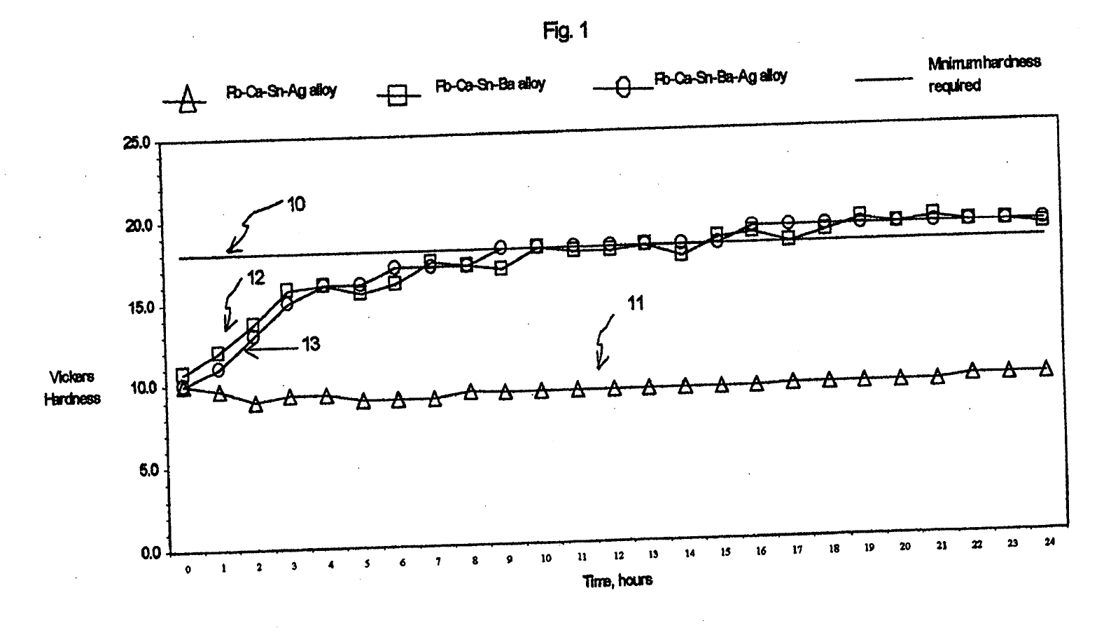

Pursuant to the invention and referring to the FIG. 1, age hardening of battery grids casted by the book molding at room temperature from different alloys are shown. On this figure, the minimum recommended Vickers hardness for a good handling of the grids during pasting and curing is indicated by line 10. The value of line 10 is a Vickers hardness of 18.

In FIG. 1, line 11 represents the age hardening of a conventional Pb—Ca—Sn—Al—Ag alloy (0.045 percent Ca, 0.92 percent Sn, 0.0125 percent Ag, 0.0130 percent Al) at room temperature. As it is shown by FIG. 1, the conventional Pb—Ca—Sn—Al—Ag alloy at room temperature only reaches Vickers hardness values below 10 after 24 hours of aging. Line 12 represents the age hardening of a Pb—Ca—Sn—Al—Ba alloy (0.051 percent Ca, 1.03 percent Sn, 0.019 percent Al, 0.016 percent Ba), and line 13 represents the age hardening of a Pb—Ca—Sn—Al—Ag—Ba alloy (0.052 percent Ca, 1.03 percent Sn, 0.0070 percent Ag, 0.017 percent Al, 0.016 percent Ba). Both alloys show a continued hardening increase, and reach the minimum hardness requirement after only 10 hours in storage at ambient temperature. Once they pass said threshold, they level out and stay well within the range needed for good battery manufacturing.

FIG. 1 illustrates that grids made from the Pb—Ca—Sn—Al—Ba and Pb—Ca—Sn—Al—Ag—Ba alloys became harder sooner than those made from a conventional Pb—Ca—Sn—Al—Ag alloy. Accordingly, grids made with a Pb—Ca—Sn—Al—Ag—Ba alloy having a composition recited above may not require age hardening at temperatures higher than room temperature as is usually the case for conventional Pb—Ca—Sn—Al—Ag alloys.

### Corrosion Tests

Corrosion testing was carried out in a comparative fashion procedure, using several techniques whose results have shown the advantages provided by the proposed alloy versus other alloys currently used in the lead-acid battery industry. The evaluations were made on both test grids and batteries made out of such grids.

In an overcharge corrosion resistance test, the grid to be evaluated is assembled into an electrochemical cell that uses a 1.270 specific gravity sulfuric acid at 60 degrees centigrade, as electrolyte. Corrosion is measured at constant potential of 1.350V against a reference electrode of mercury/mercuric sulfate. The test reproduces the corrosion created on the grids by positive voltage when the battery is being charged. The results are expressed as grid weight losses per unit of area of the tested grid.

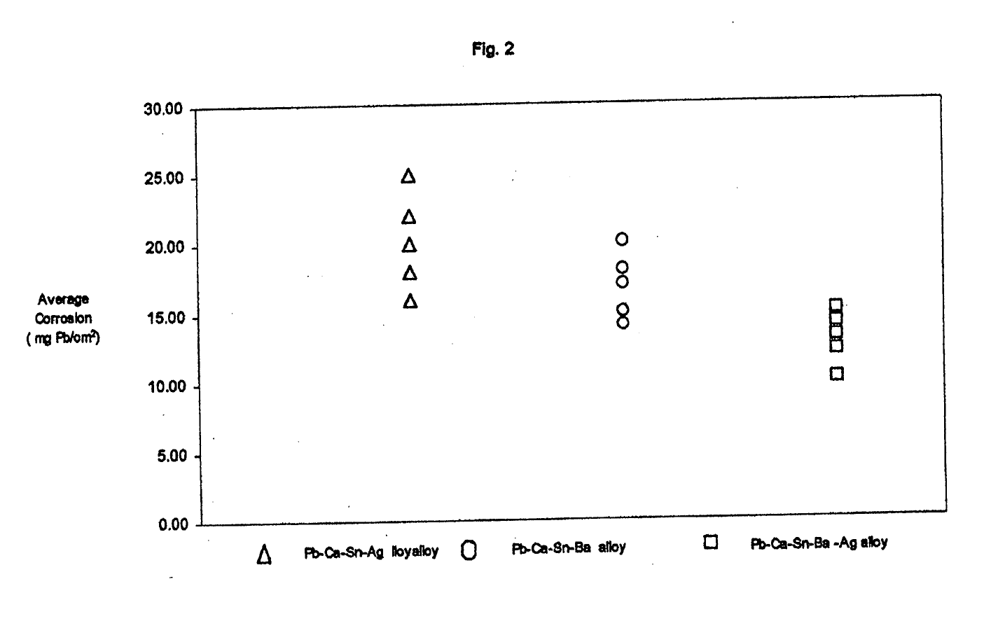

The results of overcharge corrosion resistance for three different alloys are shown in FIG. 2, plotting the grid weight losses per unit of area of the tested grid versus the type of alloy. The alloys tested were: Pb—Ca—Sn—Al—Ag alloy (0.045 percent Ca, 0.92 percent Sn, 0.0125 percent Ag, 0.0130 percent Al), Pb—Ca—Sn—Al—Ba alloy (0.051 percent Ca, 1.03 percent Sn, 0.019 percent Al, 0.013 percent Ba) and Pb—Ca—Sn—Al—Ag—Ba alloy (0.052 percent Ca, 1.03 percent Sn, 0.0095 percent Ag, 0.017 percent Al, 0.016 percent Ba). Evidence from these results has shown that the corrosion of battery grids is reduced, in comparison to Pb—Ca—Sn—Al—Ag and Pb—Ca—Sn—Al—Ba alloys, when the grids are made with Pb—Ca—Sn—Al—Ag—Ba alloys (according to any exemplary embodiment).

In a corrosion evaluation test using impedance measurements, the grid of the alloy to be evaluated is assembled into an electrochemical cell, which uses a 1.270 specific gravity sulfuric acid electrolyte, and consists of the grid itself working against a counter electrode and a reference electrode. Those three electrodes are connected to a potentiostat, and a 1.350V potential is maintained between the grid and the reference electrode throughout the test. The ohmic drop is evaluated using an impedance analyzer, and readings are averaged during 5 minute intervals. The readouts are taken periodically and are plotted against time. The end of the test is shown by a sharp increase in the readout (i.e. impedance/resistance in Ohms). The length of time it takes to reach the end of the test is directly related to the corrosion rate. The longer it takes until the sample is at the end of the test, the better its corrosion resistance (ability). Performance of grids made out of different alloys can be quantitatively compared with this method.

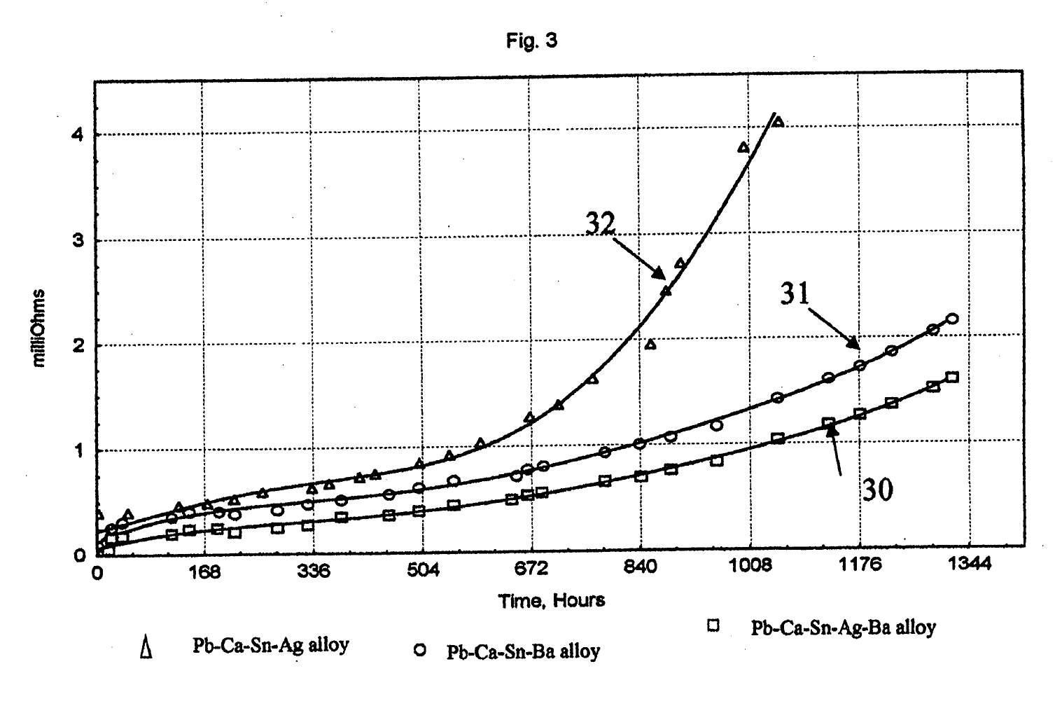

The alloys tested were: Pb—Ca—Sn—Al—Ag alloy (0.045 percent Ca, 0.92 percent Sn, 0.0125 percent Ag, 0.0130 percent Al) represented by line 32 of FIG. 3; Pb—Ca—Sn—Al—Ba alloy (0.051 percent Ca, 1.03 percent Sn, 0.019 percent Al, 0.013 percent Ba) represented by line 31 of FIG. 3 and Pb—Ca—Sn—Al—Ag—Ba alloy (0.052 percent Ca, 1.03 percent Sn, 0.0095 percent Ag, 0.017 percent Al, 0.016 percent Ba) represented by line 30 of FIG. 3. Evidence from results shown in FIG. 3 indicates the overcharge corrosion resistance results presented in FIG. 2. The corrosion of battery grids is reduced, in comparison to Pb—Ca—Sn—Al—Ag and Pb—Ca—Sn—Al—Ba alloys, when the grids are made with Pb—Ca—Sn—Al—Ag—Ba alloys (according to any exemplary embodiment).

### Field Tests

Batteries assembled with Pb—Ca—Sn—Al—Ba (0.051 percent Ca, 1.03 percent Sn, 0.019 percent Al, 0.013 percent Ba) alloy grids were mounted in fleet of automobiles (taxi cabs) in order to perform a “real life” performance evaluation of the alloy. (The nature of use of a taxi cab is believed to provide an “acceleration” factor for rapid evaluation of the alloy.) Another fleet of taxi cabs was fitted with batteries assembled with the standard Pb—Ca—Sn—Al—Ag (0.045 percent Ca, 0.92 percent Sn, 0.0125 percent Ag, 0.0130 percent Al) alloy commonly utilized in the products of the applicant, which does not contain barium. A third fleet of taxi cabs was fitted with batteries assembled with Pb—Ca—Sn—Al—Ag—Ba (0.052 percent Ca, 1.03 percent Sn, 0.0095 percent Ag, 0.017 percent Al, 0.0160 percent Ba) alloy grids to evaluate the performance of lead alloys containing both silver and barium. The batteries of the three fleets were maintained in service for about 15 months and were subsequently analyzed in the laboratory having shown a significant difference in corrosion level: 55 percent of batteries assembled with Pb—Ca—Sn—Al—Ba alloy grids failed during this period; 41 percent of the batteries assembled with Pb—Ca—Sn—Al—Ag—Ba alloy; and 48 percent of the batteries assembled with Pb—Ca—Sn—Al—Ag alloy failed. The most common failure mode of the batteries in these field tests was “grid growth.” Grid growth (which is termed creep) typically results in an electrical short circuit of the cell elements within a battery, (i.e. a positive grid/plat contacts the strap of a negative grid/plate causing an internal electrical short circuit in the battery). (Elevated “under the hood” temperatures of operation of modern automobiles worsen the problem.)

According to an exemplary embodiment, the chemical composition of the positive grids consists essentially of about 0.05 to 0.07 wt percent calcium; about 0.09 to 1.3 wt percent tin; about 0.006 to 0.010 percent silver; about 0.0100 to 0.0170 wt percent barium and about 0.015 to 0.025 wt percent aluminum, with the balance being lead.

The test data appears to provide support for a view that batteries made with positive grids using such an alloy have improved hardening performance with respect to the silver without barium alloy, and improved corrosion performance with respect to the barium without silver alloy. Such an alloy is understood to improve two performance parameters (manufacturability through a faster hardening alloy and a battery with an improved useful life). The reduced silver level used is intended to mitigate the problem of silver elimination from the stream of recycled lead in the secondary production of this metal.

It is important to note that the alloy as described in the exemplary embodiments is illustrative only. Although only a few embodiments of the present invention has been described in detail in this disclosure, those skilled in the art who review this disclosure will readily appreciate that many modifications are possible (e.g. variations in combinations and subcombinations of the amounts of the alloy elements) without materially departing from the novel teachings and advantages of the subject matter recited in the claims. Accordingly, all such modifications are intended to be included within the scope of the present invention as defined in the appended claims. The order or sequence of any process or method steps may be varied or re-sequenced according to alternative embodiments. Other substitutions, modifications, changes and omissions may be made in the exemplary embodiments without departing from the spirit of the present inventions as expressed in the appended claims.

The term “percent” as used according to any exemplary embodiment is intended to be “percent by weight.”

1. A lead alloy for use in lead-acid battery grids consisting essentially of:
between approximately 0.05 and 0.07 percent calcium;
between approximately 0.9 and 1.3 percent tin;
between approximately 0.006 and 0.010 percent silver;
between approximately 0.010 and 0.017 percent barium; and
between approximately 0.015 and 0.025 percent aluminum;
with the balance being lead.

2. The method of claim 1 wherein the lead alloy comprises intermetallic precipitates in a lead rich matrix.

3. The method of claim 1 wherein the lead alloy is configured to allow formation of battery grids without the need to perform a high temperature age hardening process.

4. The method of claim 1 wherein the lead alloy comprises approximately 0.52 percent calcium, approximately 1.03 percent tin, approximately 0.007 percent silver, approximately 0.017 percent aluminum, and 0.016 percent barium.

5. The method of claim 1 wherein the lead alloy comprises approximately 0.52 percent calcium, approximately 1.03 percent tin, approximately 0.0095 percent silver, approximately 0.017 percent aluminum, and approximately 0.016 percent barium.

6. A lead-acid battery comprising:
a container having a plurality of cells, each of the plurality of cells comprising an electrolyte and a plurality of positive grids;
wherein at least one of the plurality of positive grids comprises an alloy consisting essentially of:
between approximately 0.05 and 0.07 percent calcium;
between approximately 0.9 and 1.3 percent tin;
between approximately 0.006 and 0.010 percent silver;
between approximately 0.010 and 0.017 percent barium; and
between approximately 0.015 and 0.025 percent aluminum;
with the balance being lead.

7. The method of claim 6 wherein the alloy comprises intermetallic precipitates in a lead rich matrix.

8. The method of claim 6 wherein the alloy is configured to allow formation of battery grids without the need to perform a high temperature age hardening process.

9. The method of claim 6 wherein the alloy comprises approximately 0.52 percent calcium, approximately 1.03 percent tin, approximately 0.007 percent silver, approximately 0.017 percent aluminum, and 0.016 percent barium.

10. The method of claim 6 wherein the alloy comprises approximately 0.52 percent calcium, approximately 1.03 percent tin, approximately 0.0095 percent silver, approximately 0.017 percent aluminum, and approximately 0.016 percent barium.

11. A method of producing a battery grid comprising:
providing a lead alloy consisting essentially of between approximately 0.05 and 0.07 percent calcium, between approximately 0.9 and 1.3 percent tin, between approximately 0.006 to 0.010 percent silver, between approximately 0.010 and 0.017 percent barium; and between approximately 0.015 and 0.025 percent aluminum, with the balance of the alloy being lead; and
forming a grid from the lead alloy in a process comprising book mold gravity casting.

12. The method of claim 11 wherein the battery grid is produced without a high temperature hardening step.

13. The method of claim 11 wherein the lead alloy comprises approximately 0.52 percent calcium, approximately 1.03 percent tin, approximately 0.007 percent silver, approximately 0.017 percent aluminum, and 0.016 percent barium.

14. The method of claim 11 wherein the lead alloy comprises approximately 0.52 percent calcium, approximately 1.03 percent tin, approximately 0.0095 percent silver, approximately 0.017 percent aluminum, and approximately 0.016 percent barium.

15. The method of claim 11 wherein the lead alloy comprises intermetallic precipitates in a lead rich matrix.
